(19) United States
(12) Patent Application Publication
(10) Pub. No.: US 2007/0227204 A1
(43) Pub. Date: Oct. 4, 2007

(54) Remotely actuated refrigerator lock

(75) Inventor: Norman A. Shoenfeld, Livingston, NJ (US)

Correspondence Address: BERNHARD P. MOLLDREM, JR., 224 HARRISON STREET, SUITE 200, SYRACUSE, NY, 13202, US

(73) Assignee: S&S Xray Systems, Inc.

(21) Appl. No.: 11/391,986

(22) Filed: Mar. 29, 2006

(51) Int. Cl. E05B 65/06

(52) U.S. Cl. 70/101

(57) ABSTRACT

A remotely actuable refrigerator door lock has a body portion that is attached to the cabinet and a door portion that is attached to an edge of the door. A latch in the body portion engages a strike plate in the door portion and can be lifted out of engagement to open the refrigerator. The door lock assembly is connected to a remote host computer via a USB or ethernet connection. The host computer keeps an audit trail of the times and personnel accessing each refrigerator. The system may be used in hospital for controlling access to pharmaceuticals or may be used in a weight loss program. A key lock can provide access in the event of a power failure.

### BACKGROUND OF THE INVENTION

This invention relates to an electronic lock that mounts on the front door of a refrigerator to limit access to the refrigerator. The invention is more specifically directed to a refrigerator door lock that connects to a remote computer system, e.g., in a hospital or health care facility, to secure pharmaceuticals that need to be refrigerated, and to facilitate keeping an audit trail of access to the refrigerator. The invention may also be employed as an adjunct to a weight loss program.

In general, pharmaceuticals are delivered to patients when needed, and those that need to be kept refrigerated are stored in a refrigerator in the pharmacy of the hospital or other facility. However, it is more convenient and better use of the nurse's time and efforts to keep the pharmaceuticals at the patient locations, i.e., in the patient's room or ward, or in the cluster of rooms where the patient is located. However, those drugs that need refrigeration cannot simply be stored in a secured dispensing cabinet at the room or nurse station, but have to be kept in a refrigerator until needed. The refrigerator is either unsecured, or is kept locked with a key lock, with the key distribution limited only to certain persons in the nursing staff and pharmacy staff. Any record of access to the refrigerator would have to be maintained on a paper record, or by separately keying in information on separate computer work station. There is also no means provided to ensure that the refrigerator is kept locked, to alarm if the refrigerator is left open or unlocked, or to monitor the refrigerator's operating temperature.

It would be desirable to employ a refrigerator as a pharmacy cabinet at the patient location in which medications that have been prescribed for a patient can be loaded by pharmacy staff and stored securely until administered to the patient, which will automatically keep track of access to the refrigerated cabinet, and which can be accessed by the nurse staff electronically (e.g., using wireless means). It is also desirable to ensure that the refrigerated cabinet is kept secure, and that the operating temperature is sufficiently cool. However, no measure exists, up to the present, to carry this out.

A similar problem exists for selectively locking and unlocking a food storage refrigerator at specific meal times in a weight loss or weight control problems.

### OBJECTS AND SUMMARY OF THE INVENTION

Accordingly, it is an object of the present invention to provide a remotely actuated refrigerator door locking arrangement that avoids the drawbacks of the prior art.

It is another object to provide a locking refrigerated cabinet and keeps track of the identity or persons accessing the refrigerator and times of such access, for each of a number of refrigerators or refrigerated cabinets throughout a facility that are provided with similar remotely actuated door locks.

It is still another object to provide a refrigerator door lock that senses whether the door is open or closed, signals the remote computer system about the open/closed status of the door, and provides status of the interior temperature of the refrigerator cabinet.

A further object is to provide an audible indication, e.g., with a sounder contained in the door lock enclosure, when the refrigerator door has been kept open longer than a predetermined, programmed time limit.

Another object is to provide the electronic door lock mechanism with a key lock override that can be used, e.g., during a power outage, to obtain access to the medications kept in the refrigerator.

In accordance with an aspect of the present invention, a refrigerator is provided with a remotely opened lock, where the refrigerator is used for storing medications or other substances where access has to be controlled. The lock is opened electronically using a USB or ethernet cable (or similar serial cable device) that is connected to a computer or computer network. The lock may include a temperature detector to monitor whether the temperature level inside the refrigerator cabinet is acceptable for the stored pharmaceuticals or other perishable products. In combination with the lock device, software which may be in the remote computer system, keeps an audit trail of when the refrigerator was opened, and who opened it. The same software and network can control multiple locks on different refrigerators throughout a facility, i.e., nursing home, hospital, or other health care facility.

According to a preferred embodiment, a remotely actuable refrigerator door lock arrangement locks and unlocks a refrigerator cabinet. The lock arrangement has a body portion that mounts onto the body of the refrigerator cabinet and a door portion that mounts onto the door or the refrigerator cabinet aligning with the body portion when the refrigerator door is closed. The door portion has an enclosure that mounts to the door, with a latch strike member, i.e., latch strike plate, situated within the enclosure. The lock body portion likewise has an enclosure that mounts onto the body of the refrigerator cabinet. A latch member projects from the enclosure to engage the latch strike member. A motor drive mechanism, which may include a servo motor, moves said latch member from an engaged or lowered position, in engagement with the latch strike member, to a released or raised position out of engagement with the latch strike member so as to unlock the refrigerator. A USB cable extends from the enclosure of the body portion to connect, either directly or via a network, with a remote computer system. An electronics circuit board within the enclosure of the body portion has circuitry for communicating over the USB cable with said remote computer system, and has circuitry, e.g., a microprocessor, that is suitably programmed circuit means for receiving and interpreting commands specific to that specific refrigerator door lock to actuate said motor drive and move the latch member out of engagement with said latch strike member, to provide authorized access to the pharmaceutical refrigerator. The door portion may preferably have a key lock cylinder that is mechanically coupled to the latch strike member, so that the lock can be manually opened, by moving the latch strike member out of engagement with the latch member.

In a preferred arrangement, the latch member has a slant distal surface for moving the latch member over the strike member when the refrigerator door is pushed to its closed position, and also has a recess proximal of that slant surface for engaging said latch strike member so it remains in locked engagement until the latch member is lifted to the release position.

A magnetic (or other equivalent) sensor mechanism within said door lock senses the open/closed state of said refrigerator door. In one embodiment, the sensor mechanism includes a magnet positioned in the enclosure of the door portion and a magnetic sensor portion positioned in the body portion to sense the presence of the magnet when said refrigerator door is closed. The door lock can also incorporate a sounder device that actuated when said door lock has been sensed to be in its open state longer than a predetermined time limit.

An LED (which may be a two-way Red/Green LED) or other visible indicator is situated in door portion of the lock further comprises a visible indicator showing the open/closed status of the refrigerator door lock.

The remote computer system preferably includes software assigning a respective serial number code to each individual refrigerator door lock permitting said remote computer system to lock and unlock independently each of a plurality of door locks similarly connected with said remote computer system. The software can also include audit trail programming for recording time of opening of each refrigerator door lock connected with said remote computer system and also recording identity of each requesting person associated with such openings of the refrigerator door lock.

The pharmacy staff can distribute the various patient prescription orders e.g., during non-busy hours, and deposit the temperature sensitive medications into the patient refrigerator. Then the medications are ready for the nurse or other care giver to administer on schedule, without having to bring a cart from room to room.

Similar refrigerator or temperature controlled cabinets may be used in the radiology laboratory for controlled storage of items such as radiology contrast materials of or other temperature-sensitive pharmaceuticals.

The above and many other objects, features, and advantages of this invention will become apparent from the ensuing description of a selected preferred embodiment, which is to be considered in connection with the accompanying Drawing.

### BRIEF DESCRIPTION OF THE DRAWING

FIG. 1 is a schematic view of a network-connected system including medication storage refrigerator(s) with the door lock arrangement according to one preferred embodiment of this invention.

FIG. 2 is a perspective view of the embodiment.

FIG. 3 is a side view of this embodiment

FIG. 4 is front view of this embodiment.

FIG. 5 is a top view of this embodiment.

### DETAILED DESCRIPTION OF THE PREFERRED EMBODIMENT

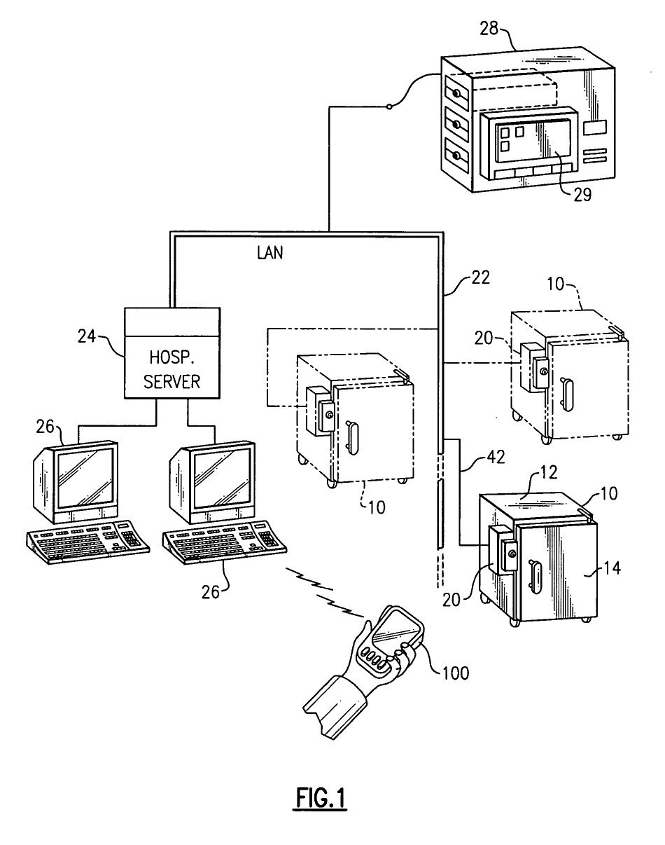

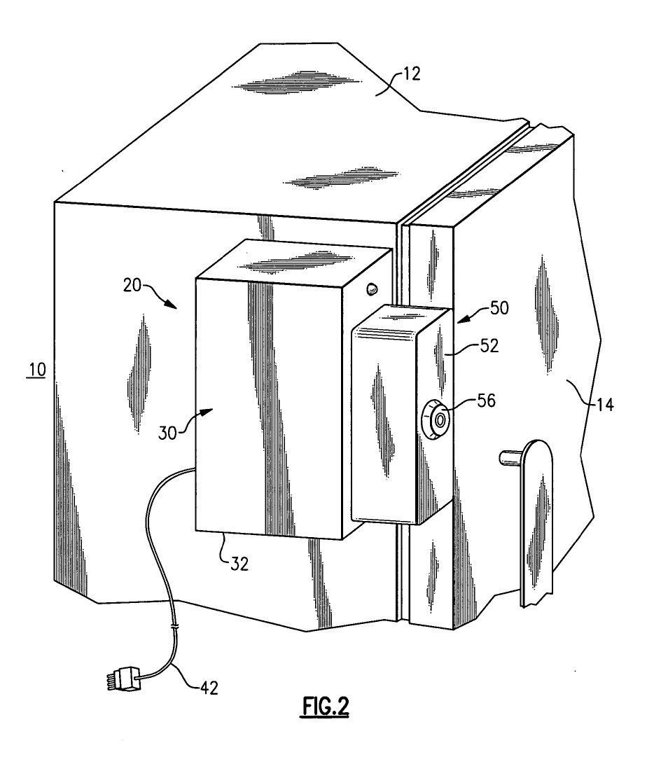

With reference to the Drawing, and initially to FIGS. 1 and 2, a medication dispensing arrangement in a hospital or other health care facility employs one or more small refrigerators 10 in the patient rooms (or at the hubs of clusters of patient rooms) for storage and controlled access to medications and pharmaceuticals that need to be kept refrigerated. The refrigerator 10 has a cabinet body 12 and a door 14 that closes over the front of the cabinet body. In the illustrated embodiment, the door 14 is hinged at the right and opens from the left, but the refrigerator could as easily be a right-opening version. Typically, the door and cabinet have a magnetic closure of sufficient strength to maintain compression on the door seal. In this embodiment, the refrigerator has attached onto it a remote actuation door lock assembly 20, as described in more detail later. The door lock assembly is connected electrically or electronically via a network 22, e.g., a LAN, that makes either a wired or wireless connection with a hospital computer server 24, to which one or more work station computers 26, 26 are connected. The LAN 22 can also connect with door lock assemblies 20 for additional med storage refrigerators 10, here shown in broken line. These may be located in other patient rooms or in other locations throughout the facility.

Also shown here is a wall mounted medications cabinet 28, which may be mounted on the wall of the patient room in which the refrigerator 10 is located, and which is also coupled electronically with the hospital LAN 22. The purpose of the wall mounted cabinet 28 is to provide controlled access in the patient's room to non-refrigerated medications in one or more computer locked drawers. In this version, the cabinet 28 has an associated touch-screen computer 29 on which the nurse or other authorized health care provider can enter an authorization code to achieve access to the cabinet drawer(s). The same touch screen computer 29 may be used via the LAN 22 to release the lock mechanism on the refrigerator lock 20. Alternatively, the health care provider may employ a wireless hand-held device 100 that communicates with one of the computer work stations 26 to unlock the refrigerator lock 20.

In an alternative embodiment, e.g., in a physician's office, the refrigerator may be free standing, and have the lock 12 coupled to a local computer or to a small LCD device with a programmed microprocessor, which may be mounted on the refrigerator, for entering an unlock code to open the refrigerator, and which will keep an audit trail of the times of opening and closing.

As shown in more detail in FIG. 2, the refrigerator door lock assembly 20 has two main components, namely, a body portion 30, with an enclosure or housing 32 that is affixed onto a side wall of the refrigerator cabinet body 12, and a door portion which has an enclosure or housing 52 that is affixed to an edge of the door 14, and which is aligned with the body portion 30. The body portion 30 and door portion 50 are shown here mounted on the left side wall of the cabinet body and left edge of the door, but the housing is adapted to be mounted on either the left or right side, depending on the side on which the refrigerator door opens.

An indicator LED 33 is shown here on the front wall of the body portion 30, to show the locked/unlocked status, and a USB cable 42 or ethernet cable extends from the body portion for attaching to the LAN 22 or otherwise to the remote computer, i.e., the hospital server 24. A key lock 56 is provided on the door portion 50 to permit the refrigerator lock to be unlocked manually, e.g., in the event of a power failure or computer system failure or outage.

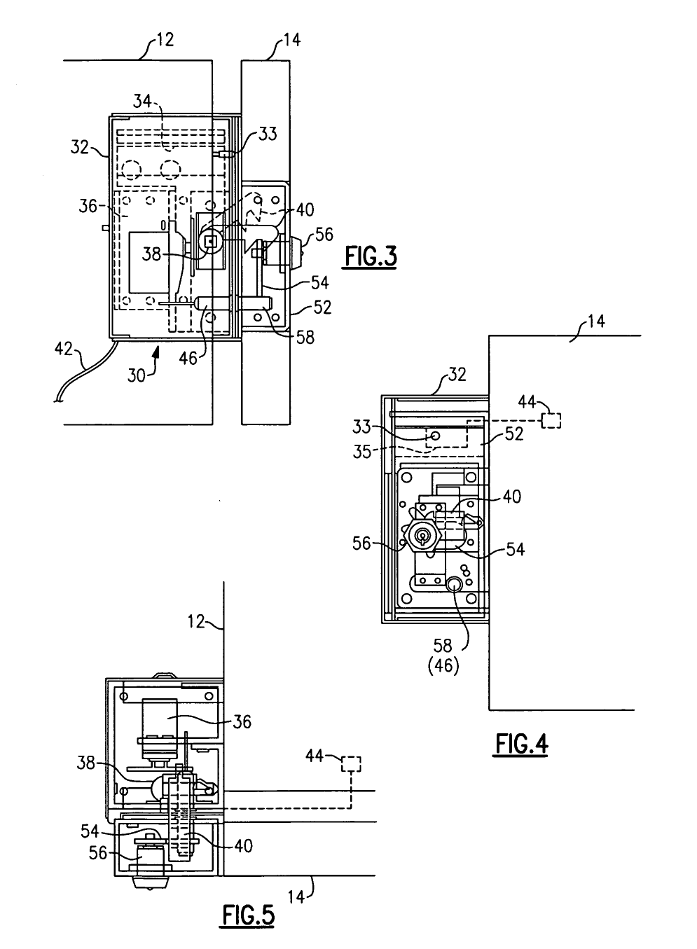

The interior arrangements of the body portion 30 and door portion 50 of the refrigerator lock assembly are shown in more detail in FIGS. 3, 4, and 5.

Within the housing 32, the body portion 30 contains an electronics circuit board 34, which includes an ethernet port or USB port and suitably programmed controller microprocessor, which can be programmed to accept and/or transmit self-descriptive command data packets, so that the hospital computer system will assign each refrigerator lock assembly a unique identifier code. As is well known in the art, an interpretive communicative software driver within the hospital server 24 or other host computer contains and/or uses a library of pre-defined peripheral USB drivers to control the USB-based door lock assemblies. A customized USB driver engineered specifically for this refrigerator lock can also be uploaded onto the hospital server. A similar system is employed when ethernet or other network system is employed. The host computer assigns a unique code or serial number for each individual refrigerator door lock assembly 20. This permits the computer system to lock and unlock each of a large number of refrigerator door locks independently or one another.

The circuit board 34 also provides drive power to a servo motor and drive 36 for unlocking or releasing the door portion 50. In this embodiment, there is a transverse pivot pin 38 on which a latch lever 40 is pivoted for motion between a lower latched position (shown in solid) and a raised unlatched position (shown in ghost or broken line). The latch lever 40 has a slanting nose surface at its distal end, and a recess behind this for securing a latch strike plate 54 in the door portion 50. The slanting nose surface allows the lever to lift and then drops to latch and capture the strike plate when the refrigerator door closes.

The USB or ethernet cable 42 plugs into a suitable socket or jack on the circuit board 34. A serial-ethernet bridge interface may be used here. The host computer, e.g. hospital server 24, may use a Window, UNIX, LINUX or other suitable system. The system can employ a card reader, e.g., bar code or magnetic stipe, RFID, or smart-card reader to provide access and unlock the lock assembly 20, in which case access may be by means of a card or badge carried by the health care provider. A suitable reader device could be installed within the medications cabinet 28 in the same room as the refrigerator.

The power for the latch motor servo can be provided from the USB port, or suitable DC can be obtained from the LAN to power the motor 36 (and also power the LED indicator 33 and sounder 35). Alternatively, an internal battery may be used in the body portion enclosure 32, or power can be derived from the associated refrigerator 10. An external DC power supply may also be used.

Also shown here are a temperature sensor 44 that is positioned in the interior of the cabinet body 12 and connects by wire to the circuit board 34. A magnetic proximity sensor is disposed at a front surface of the body portion 30, and is coupled to the circuit board 34 to provide an indication of the open/closed status of the door 14, which can then be communicated via the cable 42 and LAN 22 to the hospital computer system. The system can be programmed to alert the pharmacy personnel if one of the refrigerators fails to maintain a sufficiently cool interior temperature.

The LED lock/unlock status indicator 33 in this embodiment is adapted to glow red when the lock assembly 20 is locked, and to glow green when the lock assembly is unlocked. A no-glow or dark indication then indicates a fault or possible system failure. Flashing on-off intermittently can indicate, e.g., a temperature problem, i.e., that the sensor 44 has detected a high temperature condition.

An audible sounder 35 within the body portion housing 32 emits a tone or buzz if the refrigerator door remains open for a time that exceeds a predetermined time limit. The time limit can be programmed, e.g., from one of the work stations 26. The sounder alerts the nurse or other authorized attendant to close the refrigerator door, if the door has been inadvertently left open.

The distal end of the latch lever 40 protrudes out beyond the front wall of the body portion enclosure 32, and there is also an access opening at the rear wall of the door portion enclosure 52 to permit entry of the latch lever 40 so it can engage the strike plate 54. In this embodiment, the latch strike plate 54 is mounted on the key lock cylinder 56, so that the latch strike plate 54 can be rotated down and out of engagement with the latch lever, if necessary. This arrangement permits authorized personnel to open the refrigerator manually (with a key) in the event a power failure, network outage, or other event that might preclude obtaining electronic access.

Finally, a magnetic member 58 is situated in the door portion 50 and this is aligned with the magnetic proximity sensor 46 to close the sensor 46 when the door is closed. The proximity sensor 46 remains in its open state when the door is open and the magnetic member is not in proximity.

Other arrangements employing the same general principles can be used in other environments where there is a need to control access to the contents of the refrigerator. One possibility is in connection with a weight control program where access to food is limited to meal times so as to prevent or discourage snacking. Another possibility is in a hospitality environment, where access to reserve supply refrigerators in hospitality suites are to be limited to authorized hotel staff or catering personnel.

In a preferred embodiment, the hospital computer system keeps track of the times each refrigerator is unlocked, and the of identities of authorized personnel who obtain (or attempt to obtain) access, i.e., the system creates an audit trail of health providers who request access.

While the invention has been described hereinabove with reference to selected preferred embodiments, it should be recognized that the invention is not limited to those precise embodiments. Rather, many modification and variations would present themselves to persons skilled in the art without departing from the scope and spirit of this invention, as defined in the appended claims.

1. Remotely actuable refrigerator door lock for locking and unlocking a refrigerator which has a cabinet with a body and a door that closes against said body, with a body portion that mounts onto the body of the refrigerator cabinet and a door portion that mounts onto the door to align with the body portion when the refrigerator door is closed;
the door portion comprising
an enclosure that mounts to the door; and
a latch strike member within said enclosure;
the body portion comprising
an enclosure mounting to the body of the refrigerator cabinet;
a latch member projecting from the enclosure to engage said latch strike member,
a motor drive mechanism for selectively moving said latch member from engagement with said latch strike member to unlock the refrigerator;
a cable extending from the enclosure of the body portion for connecting with an external computer arrangement; and
suitably programmed circuit means within the enclosure of the body portion for communicating over said cable with said computer arrangement for receiving commands specific to the refrigerator door lock to actuate said motor drive to move the latch member out of engagement with said latch strike member.

2. Remotely actuable refrigerator door lock of claim 1 in which said door portion further includes a key lock cylinder mechanically coupled to said latch strike member for moving said latch strike member out of engagement with said latch member.

3. Remotely actuable refrigerator door lock of claim 1 wherein said latch member has a slant distal surface for moving said latch member over said latch strike member when the refrigerator door is pushed to its closed position, and a recess proximal of said slant surface for engaging said latch strike member.

4. Remotely actuable refrigerator door lock of claim 1 further comprising sensor means within said door lock for sensing an open/closed state of said refrigerator door.

5. Remotely actuable refrigerator door lock of claim 4 wherein said sensor means includes a magnet positioned in the enclosure of said door portion and a sensor positioned in said body portion to sense the presence of said magnet when said refrigerator door is closed.

6. Remotely actuable refrigerator door lock of claim 1 wherein said door portion further comprises a visible indicator showing the open/closed status of the refrigerator door lock.

7. Remotely actuable refrigerator door lock of claim 1 wherein said computer arrangement includes software assigning a respective serial number code to each individual refrigerator door lock permitting said computer arrangement to lock and unlock independently each of a plurality of door locks similarly connected with said remote computer system.

8. Remote actuable refrigerator door lock of claim 7 wherein said software includes audit trail means for recording time of opening of each refrigerator door lock connected with said remote computer system and also recording identity of each requesting person associated with such openings of the refrigerator door lock.

9. Remotely actuable refrigerator door lock of claim 4 further comprising a sounder device actuated when said door lock has been sensed to be in its open state longer than a predetermined time limit.

10. Remotely actuable refrigerator door lock of claim 1 further including a temperature monitor having a probe sensing temperature inside said refrigerator cabinet, the monitor being coupled with said suitably programmed circuit means for communicating said temperature to said remote computer system.

11. Remotely actuable refrigerator door lock of claim 10, comprising a visible indicator which flashes to indicate said temperature is above a predetermined threshold.

12. Remotely actuable refrigerator door lock of claim 1 wherein suitably programmed circuit means includes a USB interface.

13. Remotely actuable refrigerator door lock of claim 1 wherein said suitably programmed circuit means includes an ethernet interface.

14. A refrigerator door lock for locking and unlocking a refrigerator which has a cabinet with a body and a door that closes against said body, with a body portion that mounts onto the body of the refrigerator cabinet and a door portion that mounts onto the door to align with the body portion when the refrigerator door is closed; and comprising a control and display arrangement located external to said body portion;
the door portion comprising
an enclosure that mounts to the door; and
a latch strike member within said enclosure;
the body portion comprising
an enclosure mounting to the body of the refrigerator cabinet;
a latch member projecting from the enclosure to engage said latch strike member;
a motor drive mechanism for selectively moving said latch member from engagement with said latch strike member to unlock the refrigerator;
means connecting with said external control and display arrangement; and
suitably programmed circuit means within the enclosure of the body portion for communicating with said control and display arrangement for receiving commands specific to the refrigerator door lock to actuate said motor drive to move the latch member out of engagement with said latch strike member.

15. Refrigerator door lock of claim 14 further comprising sensor means within said door lock for sensing an open/closed state of said refrigerator door.

16. Refrigerator door lock of claim 15 further comprising a visible indicator showing the open/closed status of the refrigerator door.

17. Refrigerator door lock of claim 14 wherein said control and display arrangement includes software for identifying individuals having access to open the refrigerator; and said software further includes audit trail means for recording time of opening of the refrigerator door lock and also recording the identity of each person accessing the refrigerator for each such opening of the refrigerator door lock.

18. Refrigerator door lock of claim 14 further including a temperature monitor having a probe sensing temperature inside said refrigerator cabinet, the monitor being coupled with said suitably programmed circuit means for communicating said temperature to said control and display arrangement.

19. Refrigerator door lock of claim 18 further including a visible indicator for indicating when said temperature is above a predetermined threshold.
